(19) United States
(12) Patent Application Publication
(10) Pub. No.: US 2015/0382077 A1
(43) Pub. Date: Dec. 31, 2015

(54) METHOD AND TERMINAL DEVICE FOR ACQUIRING INFORMATION

(71) Applicant: Xiaomi Inc., Beijing (CN)

(72) Inventors: Huadong Liu, Beijing (CN); Wu Sun, Beijing (CN); Aijun Wang, Beijing (CN); Rongxin Gao, Beijing (CN); Hong Ji, Beijing (CN)

(21) Appl. No.: 14/614,423

(22) Filed: Feb. 5, 2015

Related U.S. Application Data
(63) Continuation of application No. PCT/CN2014/091609, filed on Nov. 19, 2014.

(30) Foreign Application Priority Data
Jun. 26, 2014 (CN) 201410300209.X

(51) Int. Cl. H04N 21/81; H04N 21/262; H04N 21/433; H04N 21/432; H04N 21/458; H04N 21/239; H04N 21/437; H04N 21/4722; H04N 21/235; H04N 21/435

(52) U.S. Cl. CPC H04N 21/8133; H04N 21/235; H04N 21/26258; H04N 21/4331; H04N 21/435; H04N 21/458; H04N 21/2393; H04N 21/437; H04N 21/4722; H04N 21/4325

(57) ABSTRACT

The present disclosure relates to a method and a terminal device for acquiring information. The method comprises: acquiring associated information of at least one video element in a video, wherein each video element being an image element, a sound element or a clip in the video; and displaying the associated information at a specified time. The problem of inefficient information acquisition is solved, making it possible to display associated information of a video element in a terminal device at a specified time, thus the information acquisition efficiency is improved.

### CROSS-REFERENCE TO RELATED APPLICATIONS

This application is a Continuation Application of International Application No. PCT/CN2014/091609, filed on Nov. 19, 2014, which is based on and claims priority to Chinese Patent Application No. 201410300209.X, filed on Jun. 26, 2014, the entire contents of which are incorporated herein by reference.

### TECHNICAL FIELD

The present disclosure generally relates to the field of Internet technology, and more particularly, to a method and a terminal device for acquiring information.

### BACKGROUND

Videos, such as TV dramas, movies and the likes, are an indispensable part for people's daily life. A video may include many video elements, for example, one video may comprise various movie stars, scenic backgrounds, movie settings, classic lines from script, interludes, and so on.

When users are interested in a certain video element of a video, generally, they need to manually acquire relevant information of the video element. For example, when users need to view a blooper (or goof) in a video A, they need to locate and play the blooper by fast-forward, backward or adjusting a play progress bar in the process of playing the video A. For another example, when users need to know information relating to a race car shown in video B, they need to manually input keywords related to the race car in a browser to conduct a search, and to find the information relating to the racing car in a search result.

### SUMMARY

According to a first aspect of the embodiments of the present disclosure, there is provided a method for acquiring information in a terminal device. The method comprises: acquiring associated information of at least one video element in a video, wherein each video element being an image element, a sound element or a clip in the video; and displaying the associated information at a specified time.

According to a second aspect of the embodiments of the present disclosure, there is provided a method for acquiring information in a server. The method comprises: generating associated information of at least one video element in a video, wherein each video element being an image element, a sound element or a clip in the video; and providing a terminal device with the associated information of the at least one video element in the video, wherein the terminal device is configured to display the associated information at a specified time.

According to a third aspect of the embodiments of the present disclosure, there is provided a terminal device for acquiring information. The terminal device comprises: a processor; and a memory configured to store executable instructions from the processor, wherein, the processor is configured to perform: acquiring associated information of at least one video element in a video, wherein each video element being an image element, an sound element or an element of a clip in the video; and displaying the associated information at a specified time.

According to a fourth aspect of the embodiments of the present disclosure, there is provided a server for acquiring information, comprising: a processor; and a memory configured to store executable instructions from the processor, wherein, the processor is configured to perform: generating associated information of at least one video element in a video, wherein each video element being an image element, an sound element or a clip in the video; and providing a terminal device with the associated information of the at least one video element in the video, wherein the terminal device is configured to display the associated information at a specified time.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1A is a structure diagram showing an implementation environment according to an exemplary embodiment.

FIG. 1B is a structure diagram showing another implementation environment according to an exemplary embodiment.

FIG. 2 is a schematic diagram showing a video element and associated information according to an exemplary embodiment.

FIG. 3 is a flow chart showing a method for acquiring information according to an exemplary embodiment.

FIG. 4 is a flow chart showing a method for acquiring information according to another exemplary embodiment.

FIG. 5 is a flow chart showing a method for acquiring information according to an exemplary embodiment.

FIG. 6 is a flow chart showing associated information provided by a server according to an exemplary embodiment.

FIG. 7 is another flow chart showing associated information provided by a server according to an exemplary embodiment.

FIG. 8 is a flow chart showing a method for acquiring information according to an exemplary embodiment.

FIG. 9A is a schematic diagram showing associated information displayed by a terminal device according to an exemplary embodiment.

FIG. 9B is another schematic diagram showing associated information displayed by a terminal device according to an exemplary embodiment.

FIG. 9C is a further schematic diagram showing associated information displayed by a terminal device according to an exemplary embodiment.

FIG. 9D is a further schematic diagram showing associated information displayed by a terminal device according to an exemplary embodiment.

FIG. 9E is a further schematic diagram showing associated information displayed by a terminal device according to an exemplary embodiment.

FIG. 9F is a further schematic diagram showing associated information displayed by a terminal device according to an exemplary embodiment.

FIG. 9G is a further schematic diagram showing associated information displayed by a terminal device according to an exemplary embodiment.

FIG. 10 is a block diagram of an apparatus for acquiring information according to an exemplary embodiment.

FIG. 11 is a block diagram of an apparatus for acquiring information according to another exemplary embodiment.

FIG. 12 is a block diagram of an apparatus for acquiring information according to an exemplary embodiment.

FIG. 13A is a block diagram of an apparatus for acquiring information according to another exemplary embodiment.

FIG. 13B is a block diagram of an element identification unit according to an exemplary embodiment.

FIG. 13C is a block diagram of another element identification unit according to an exemplary embodiment.

FIG. 13D is a block diagram of an information acquisition unit according to an exemplary embodiment.

FIG. 14 is a block diagram of a device for acquiring information according to an exemplary embodiment.

FIG. 15 is a block diagram of a device for acquiring information according to an exemplary embodiment.

Specific embodiments of the present disclosure are shown by the above drawings, and more detailed description will be made hereinafter. These drawings and text description are not for limiting the scope of conceiving the present disclosure in any way, but for illustrating the concept of the present disclosure for those skilled in the art by referring to specific embodiments.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

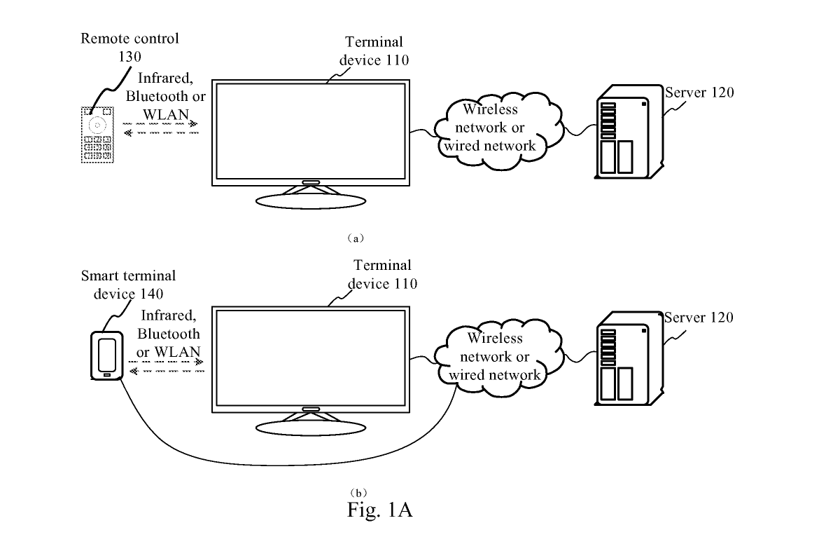

FIG. 1A and FIG. 1B show structure diagrams of implementation environment involved in the methods for acquiring information according to embodiments of the present disclosure, and the implementation environment may include a terminal device 110 and a server 120 connected to the terminal device by wired or wireless network.

As shown in FIG. 1A, the terminal device 110 may be a playback device having video playing ability such as a television, a tablet computer, a desktop computer or a mobile phone and the like. The playback device may, under the control of a remote control, directly acquire video resources from the server 120 and play the acquired video resources. Herein, the remote control may be connected to a television by infrared, Bluetooth or WLAN, and the remote control may be either a remote control 130 as shown in (a) of FIG. 1A, or a smart terminal device 140 as shown in (b) of FIG. 1A.

As shown in FIG. 1B, the terminal device 110 may be a medium source device connected to the playback device. The medium source device may be a high-definition box, a Blu-ray player, a household NAS (Network Attached Storage) device and the like. Herein, the playback device may be a device having the video playing ability such as a television, a tablet computer, a desktop computer or a mobile phone and the like. The playback device can acquire, with the help of the medium source device connected to the playback device, video resources from the server 120. The medium source device may acquire video resources from the server 120 and play the acquired video resources in the playback device. Meanwhile, users may control the medium source device by means of the remote control which is connected to the television by means of infrared, Bluetooth or WLAN, and the remote control may be either a remote control 150 as shown in (a) of FIG. 1B, or a smart terminal device 160 as shown in (b) of FIG. 1B.

In addition, the server 120 is connected with the terminal device 110 by a wired or wireless network, and the server 120 may be a single server, or a server cluster comprising a plurality of servers, or a cloud computing service center.

It should be explained that, in FIG. 1A and FIG. 1B, an implementation environment comprising the foregoing devices are taken as an example. In some application scenarios for actual implementation, the implementation environment may also comprise a part of the foregoing devices or other devices, to which the embodiment makes no restriction.

In addition, for the convenience of understanding, basic concepts involved in the embodiments are introduced herein.

A video element refers to an image element, a sound element or a clip in a video. Herein, the image element is an element in image frame data, such as a figure (or person) or an object; the sound element is a sound, being audio frame data or a plurality of consecutive audio frame data; the clip is image frame data corresponding to a time frame or a plurality of consecutive image frame data corresponding to a period of time frames (or a period of play time).

Associated information of a video element refers to information associated with the video element. For example, when a video element is a movie star, associated information may be an individual resume of the movie star, a starred work list, the latest microblog news and news report and the like about the movie star.

When a video element is a piece of clothing, associated information may be a buy link (or purchase link, buying link) of the clothing in an E-business website, a shop address for selling the clothing, a fabric composition of the clothing, and a matching recommendation of the clothing, etc.

When a video element is food, associated information may be a buying link of the food in an E-business website, a shop address for selling the food in the local place of users, and a recipe of the food, etc.

When a video element is a background music, associated information may be a MV (Music Video) corresponding to the background music, lyrics of the background music, a singer of the background music, and a creation background of the background music, etc.

When a video element is a scenic background, associated information may be a brief introduction of the scenic background, a business link for providing tourism service of the scenic background, cuisines provided in the scenic spot, and other scenic backgrounds similar to the scenic backgrounds, etc.

When a video element is a video clip, associated information may be image frame data, audio frame data, or image elements in the combination of both image frame data and audio frame data, or combination of the image elements and sound elements in the video clip.

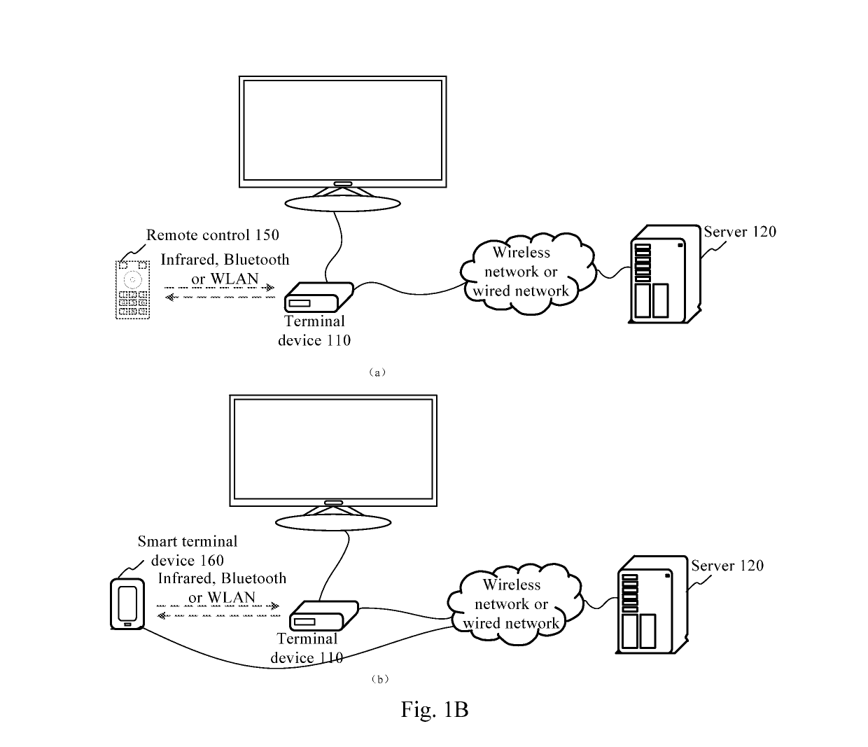

FIG. 2 shows video elements 21 in a video and associated information 22 of the video elements 21. It can be known from FIG. 2 that, the video elements may be elements of images in image frame data, or elements of sounds in audio frame data, or all elements (dash area as shown in FIG. 2) in image frame data, or m frames of image frame data or m frames of audio frame data, to which the embodiment makes no restriction. Herein, m is an integer greater than or equal to 2.

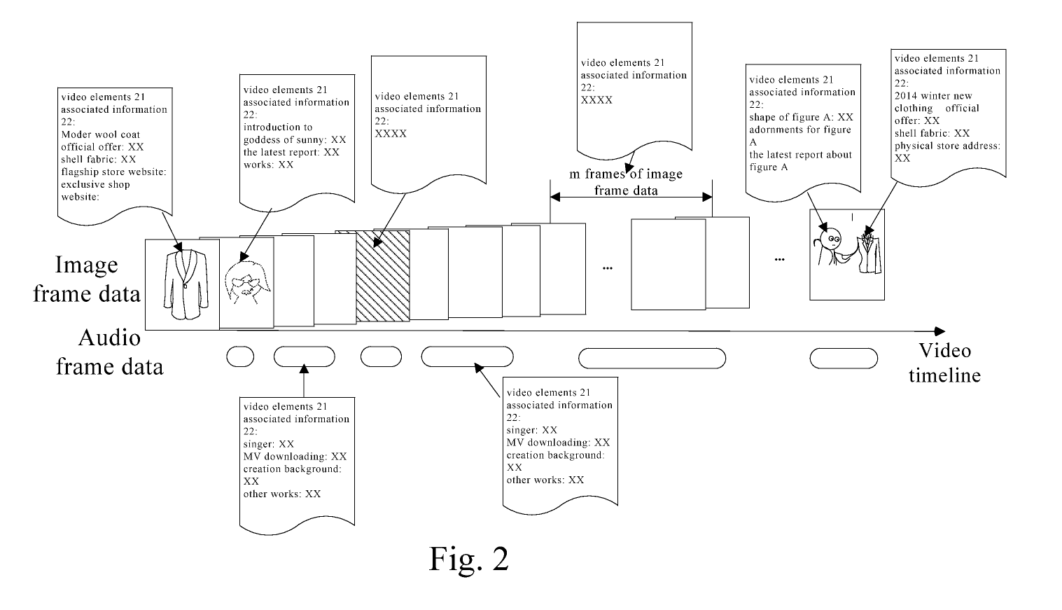

FIG. 3 is a flow chart showing a method for acquiring information according to an exemplary embodiment which is illustrated by applying the method for acquiring information to a terminal device 110 as shown in FIG. 1A or FIG. 1B, and the method for acquiring information may comprise following steps.

In Step 301, associated information of at least one video element in a video is acquired, wherein each video element is an image element, a sound element or a clip in the video.

In Step 302, the associated information is displayed at a specified time.

In conclusion, the method for acquiring information according to the embodiment, by acquiring the associated information of the video element in the video, and by displaying the associated information acquired at the specified time, thus solves the problem of inefficient information acquisition, making it possible to display associated information of a video element in a terminal device at the specified time, and improving the information acquisition efficiency.

The mode for the terminal device to acquire the associated information of the at least one video element may comprise at least one of the following modes: a mode of downloading associated information of a video element from a server at a scheduled time; a mode of searching for associated information of a video element relating to a play position in the video from the associated information of at least one video element in the video downloaded in advance, if an information acquisition instruction is received from a user when playing the certain position in the video; a mode of sending an information acquisition request to the server, and further receiving such associated information, which is fed back by the server, of a video element relating to a video play position when the information acquisition instruction is received. Reference will be made in detail to the foregoing three modes in different embodiments hereinafter.

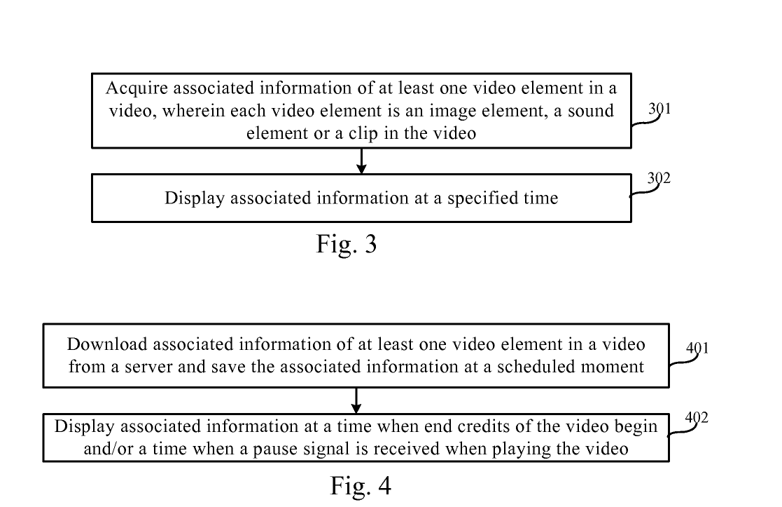

FIG. 4 is a flow chart showing a method for acquiring information according to an exemplary embodiment which is illustrated by applying the method to a terminal device 110 as shown in FIG. 1A or FIG. 1B and the terminal device 110 is able to download associated information of a video element from a server at a scheduled time. The method for acquiring information may consist of following steps.

In Step 401, associated information of at least one video element in a video is downloaded by the terminal device from the server and saved at the scheduled time.

The terminal device may request to download, from the server, the associated information of the at least one video element and save the associated information at the scheduled time. In actual implementation, the terminal device may send at the scheduled time, an information acquisition request for acquiring the associated information of the at least one video element in the video, to the server. Herein, the scheduled time includes a period prior to playing the video, a period during the video, or an idle moment.

In Step 402, the terminal device may display associated information at a time when end credits of the video begin and/or a time when a pause signal is received when playing the video.

After acquiring the associated information of the at least one video element, the terminal device may display the associated information at the time when the end credits of the video begin and/or the time when the pause signal is received when playing the video.

In a case that the terminal device displays the associated information at the time when the end credits of the video begin, the terminal device displays the associated information of the at least one video element in the video after the terminal device finishes playing the video. In this way, users may acquire the associated information of all video elements in the video, thus simplifying user operation.

In the process of playing the video, in a case of receiving the pause signal and displaying the associated information, the terminal device may pause the video after receiving the pause signal, and display the associated information of the at least one video element in the video.

In actual implementation, the terminal device may also display the associated information at a certain time frame, to which the embodiment makes no restriction.

In conclusion, the method for acquiring information according to the embodiment, by acquiring the associated information of the video element in the video, and by displaying the associated information acquired at the specified time, thus solves the problem of inefficient information acquisition, making it possible to display the associated information of the video element in the terminal device at the specified time, and improving the information acquisition efficiency.

By downloading the associated information of the at least one video element from the server at the scheduled time, the embodiment reduces complexity in interaction between the terminal device and the server when the associated information is displayed in the terminal device, and improves the efficiency of the terminal device in displaying the associated information.

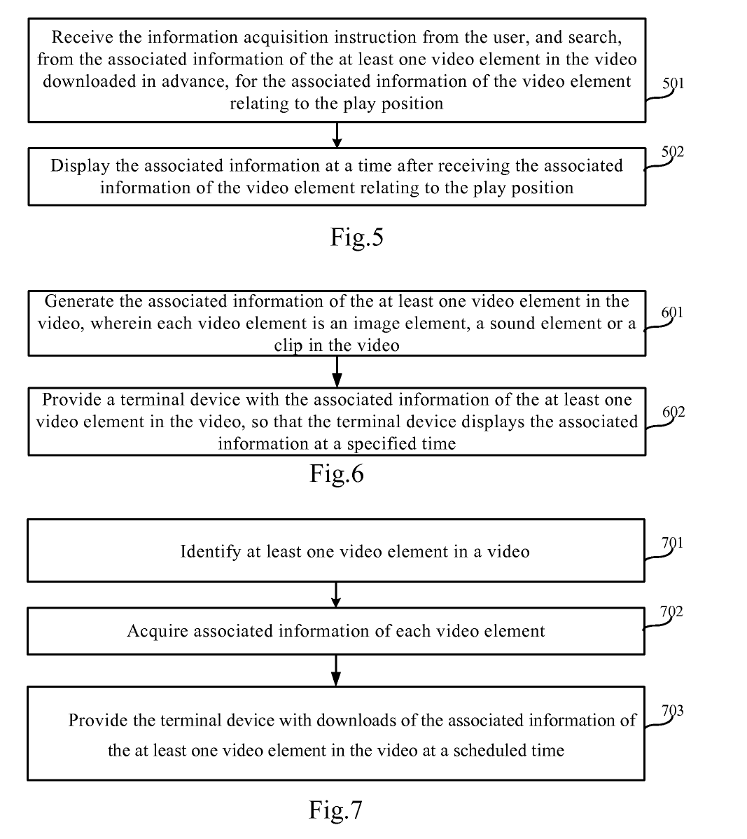

FIG. 5 is a flow chart showing a method for acquiring information according to an exemplary embodiment which is illustrated by applying the method to a terminal device 110 as shown in FIG. 1A or FIG. 1B. The terminal device 110 is able to, in case of receiving an information acquisition instruction from a user, search from associated information of at least one video element downloaded in advance, for associated information of a video element relating to a video play position when the information acquisition instruction is received. The method for acquiring information may consist of following steps.

In Step 501, the terminal device receives the information acquisition instruction from the user, and searches, from the associated information of the at least one video element in the video downloaded in advance, for the associated information of the video element relating to the play position.

In the process of playing the video in the terminal device, the user may send the information acquisition instruction to the terminal device by means of preset keys of the terminal device or a remote control if they want to acquire associated information of a video element at the current play position. Correspondingly, the information acquisition instruction from the user is received by the terminal device. Herein, the user may send out the information acquisition instruction by pressing the preset keys of the remote control. Of course, the user may also send out the information acquisition instruction by simultaneously pressing two keys such as ‘0’ and ‘Enter’ keys, to which the embodiment makes no restriction.

When receiving the information acquisition instruction, the terminal device may search, from the associated information of the at least one video element in the video downloaded in advance, for the associated information of the video element relating to the play position. In actual implementation, the terminal device may search, from the associated information, for the associated information corresponding to the play position when the information acquisition instruction is received by the terminal device.

In Step 502, the terminal device may display the associated information at a time after receiving the associated information of the video element relating to the play position.

The terminal device may display the associated information after receiving the associated information of the video element relating to the play position. In actual implementation, the user may want to acquire the associated information when he/she send out the information acquisition instruction. Therefore, the terminal device may immediately display the associated information acquired, to which the embodiment makes no restriction.

In conclusion, the method for acquiring information according to the embodiment, by acquiring the associated information of the video element in the video, and by displaying the associated information acquired at the specified time, thus solves the problem of inefficient information acquisition, making it possible to display the associated information of the video element in the terminal device at the specified time, and improving the information acquisition efficiency.

In the embodiment, when the information acquisition instruction from the user is received, the associated information of the video element relating to the video play position is searched from the associated information of the at least one video downloaded in advance, thus ensuring the terminal device to quickly acquire the associated information requested by the user, and further improving the efficiency of the terminal device in displaying associated information and enhancing the information acquisition efficiency.

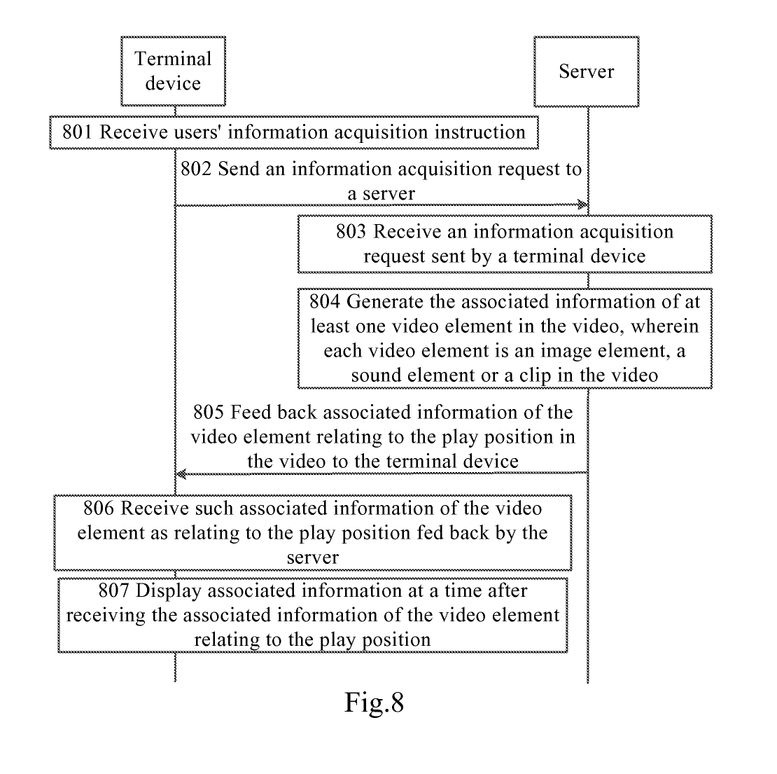

It should be explained that in the foregoing two embodiments, before the terminal device acquires associated information of video element, the server needs to generate associated information of at least one video element, and provides the terminal device with the generated associated information of the at least one video element. As shown in FIG. 6, the server may execute the method comprising the following steps.

In Step 601, the associated information of the at least one video element in the video is generated, wherein each video element is an image element, a sound element or a clip in the video.

The server stores videos for playing in a playback device, and generates the associated information of the at least one video element in the videos for executing follow-up steps. Herein, each video element is the image element, the sound element or the clip in the video.

In Step 602, the associated information of the at least one video element in the video is provided to the terminal device so that the terminal device displays the associated information at a specified time.

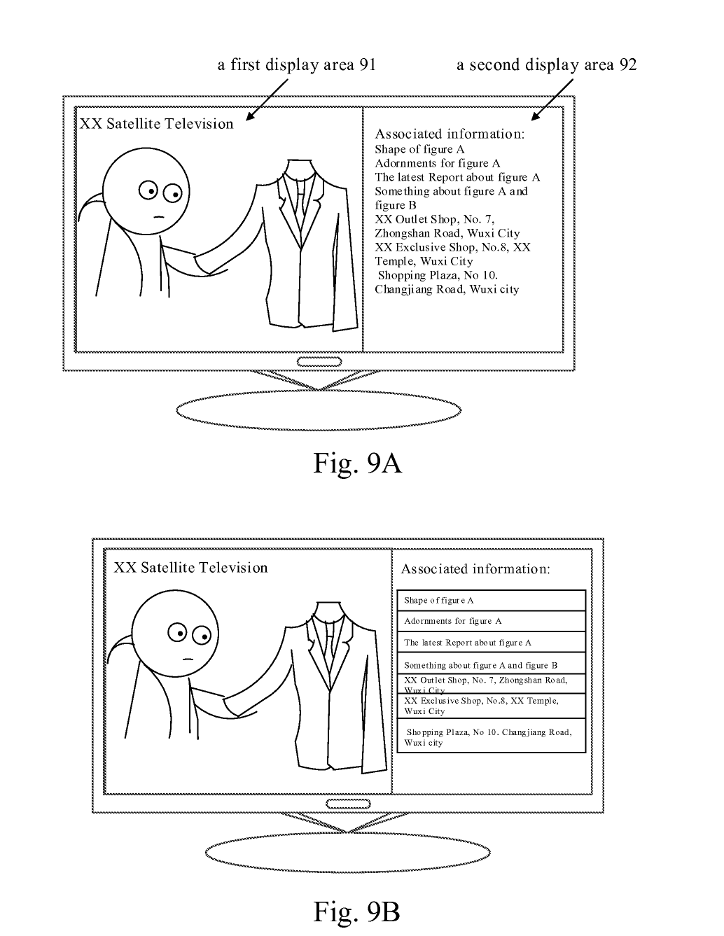

FIG. 7 is a flow chart showing associated information provided by a server according to another exemplary embodiment. As shown in FIG. 7, the server may execute the following steps.

In Step 701, at least one video element in a video is identified.

In actual implementation, this step may consist following two possible implementations.

In a first possible implementation, the Step 701 may comprise the following substeps.

(1) A video is decoded and at least one frame of video data is acquired.

A server decodes the video, and further acquires the at least one frame of video data in the video. Herein, since some play positions in the video may be configured with sound while other play positions may not be configured with sound, the server may simultaneously decode and acquire both image frame data and audio frame data at the play positions configured with sound, and may decode and acquire only image frame data at the play positions not configured with sound.

(2) Image elements in the image frame data, concerning the image frame data, are identified by means of image recognition technology.

According to the image frame data acquired by decoding, the server may identify the image elements in the image frame data by means of image recognition technology. In actual implementation, the server may match the image frame data acquired by decoding with images in an image database. If elements matching with images in the image database exist in the image frame data, the server takes the matched image elements as image elements in the image frame data. Herein, the image database is a preset database comprising images including target objects such as figures, sceneries, articles for daily use, clothing, labels, trademarks, brands and keywords, to which the embodiment makes no restriction.

For example, if the image database has an image of ‘figure A’ and an image of 2014 winter new clothing of XX brand that ‘figure A’ endorses, and an image frame data acquired by the server also includes an image of ‘figure A’ and an image of a coat among 2014 winter new clothing of XX brand, the server may take the image of ‘figure A’ and the image of the coat as image elements in the image frame data.

(3) Sound elements in the audio frame data, concerning the audio frame data, are identified by means of speech recognition (or voice recognition) technology.

According to the audio frame data, the server may identify the sound elements in the audio frame data by means of speech recognition technology. In actual implementation, the server may match audio frame data with a songbook (or a database of words and music), thus acquiring the sound elements in the audio frame data. Moreover, in order to more accurately identify the sound elements, the server may combine an audio frame data with a preset length of audio frame data before the audio frame data, or with a preset length of audio frame data after the audio frame data, or with a preset length of audio frame data before the audio frame data and a preset length of audio frame data after the audio frame data, thus acquiring a multi-frame audio frame data and matching it with the songbook, to which the embodiment makes no restriction. Herein, the songbook includes a preset database comprising audio frequencies, to which the embodiment makes no restriction.

According to the at least one frame of video data acquired by the server by decoding, the server may take each frame of video data as a unit, thus identifying the image elements or the sound elements in each frame of video data; of course, the server may take two or more frames of video data as a unit, for example, take video data between the tenth minute and the eleventh minute in a video as a clip, further take the image elements or the sound elements identified and acquired in the video data in the clip simultaneously as the video elements, to which the embodiment makes no restriction.

It should be explained that concerning a part of video data acquired by the server by decoding, the server may not identify and acquire the image elements or the sound elements from the video frame data, and may only identify and acquire the image elements or the sound elements from another part of video data, to which the embodiment makes no restriction.

In a second possible implementation, the Step 701 may be implemented by directly receiving at least one video element reported by other terminal devices with respect to the video, and the video element is one labeled by users of the other terminal devices, since the user may label each video element in the video.

In Step 702, associated information of each video element is acquired.

After acquiring at least one video element, the server may acquire the associated information of each video element. Herein, the mode in which the server acquires the associated information of the video element may comprise the two following possible implementations:

In a first possible implementation, the Step 702 may comprise the following substeps.

(1) At least one information relating to each video element is acquired by means of information search technology.

Concerning each video element identified and acquired by the server, the server may acquire at least one piece of information of the video element by means of information search technology. For example, when the video element acquired by the server is an image of ‘figure A’, the server may search from a network server for information associated with the image of ‘figure A’.

(2) The at least one information is sorted according to a preset condition, and n associated information in the front of the sorting is acquired as the associated information of the video element, wherein n being a positive integer.

The server may sort at least one piece of information acquired according to the preset condition. Herein, the preset condition comprises at least one of a correlation with the video element, a correlation with a user location, a correlation with a history (or history of usage record) of the user, and a ranking of manufacturers or suppliers of the video elements.

The correlation with the video element refers to the correlation between information searched and the video element. For example, if the video element is an image of a “figure A”, and information searched respectively is “figure A and figure B”, “the latest report about figure A”, “shape of figure A (or character A′s shape)”, “adornments for figure A” and the like, the correlation between the information searched and the video element successively is, according to a sequence from most relevant to least relevant, “shape of figure A”, “adornments for figure A”, “the latest report about figure A” and “something about figure A and figure B”.

The correlation with the user location refers to a distance between information searched and the user location. Herein, the user location is a geographic location reported by a user to the sever when a user terminal device requests to play the video in the server, for example, the geographic location reported by the user is No. 5, Zhongshan Road, Wuxi City.

For example, if a video element is an image of “a certain coat from XX brand”, information searched is “XX Exclusive Shop, No. 8, XX Temple, Wuxi City”, “XX Outlet Shop, No. 7, Zhongshan Road, Wuxi City” and “Shopping Plaza, No 10. Changjiang Road, Wuxi city”, the correlation between the information searched and the user location successively is, according to a sequence from most relevant to least relevant, “XX Outlet Shop, No. 7, Zhongshan Road, Wuxi City”, “XX Exclusive Shop, No. 8, XX Temple, Wuxi City” and “Shopping Plaza, No 10, Changjiang Road, Wuxi city”.

The correlation with the history usage record of the user refers to a correlation between information searched and associated information triggered by and used in user history. For example, if the user generally are concerned about clothing and food, and information searched by the user is information relating to automobiles, scenic spots, food and clothing respectively, the server may determine that the correlation between the information searched and user historical usage records successively is, according to a sequence from most relevant to least relevant, clothing, food, scenic spots and automobiles.

The ranking of manufacturers or suppliers of the video elements refers to a preset ranking of manufacturers or suppliers in the server, on the basis of which, the server may sort information searched.

After the server sorts the acquired information, the server may acquire n piece of information from the front of the information sorted as the associated information of the video element. For example, the server selects top 10 information of the information sorted as the associated information of the video element. Of course, in actual implementation, the server may also take all information sorted as the associated information of the video element, to which the embodiment makes no restriction.

In a second possible implementation, the Step 702 may comprise the following substeps.

As the user may report the associated information for each video element, the server may receive the associated information reported by the other terminal devices with respect to the video element. Herein, the other terminal devices are terminal devices used by other users, or, the other terminal devices are terminal devices used by manufacturers or suppliers of the video elements. The associated information reported by the other terminal devices may be information sorted according to a certain sort order, to which the embodiment makes no restriction.

It should be explained that, the manufactures or the providers of the video element may monopolize the associated information of the video element in a certain clip of a video, for example, from the tenth minute to the eleventh minute, a hero (or leading actor) in a video is selecting clothing for a news conference to be held in the next day, a manufacturer of “a certain coat from XX brand” (which represents a video element) may buy out the associated information of the video element from the tenth minute to the eleventh minute in the video. Under the circumstances, although the server may identify and acquire other video elements from video frame data from the tenth minute to the eleventh minute in the video, the server still sets “a certain coat from XX brand” (which represents information set by the manufacturer) as the associated information of the video element from the tenth minute to the eleventh minute in the video.

It should be further explained that, when the video elements identified and acquired by the server are video elements corresponding to different locations of the video, after acquiring associated information of each video element, the server may determine a play position corresponding to the associated information, and take the play position determined as a piece of attribute information of the associated information, to which the embodiment makes no restriction.

In Step 703, the server provides, at a time prior to playing a video by the terminal device, a time during a video or an idle moment, the terminal device with downloads of the associated information of the at least one video element in the video.

In actual implementation, the server may take the initiative to send the associated information of at least one video element in the video to the terminal device, or provide the terminal device with downloads to the associated information after receiving an information acquisition request sent by the terminal device.

In the example of the server taking the initiative to send associated information, after generating the associated information of at least one video element in the video, the server may directly send the associated information to the terminal device, i.e., the server may provide the terminal device with downloads to the associated information at the time before the terminal device plays the video; or, the server may send the associated information to the terminal device when the terminal device is playing the video; or the server may send the associated information to the terminal device at an idle moment of the terminal device, for example, midnight “12:00”, to which the embodiment makes no restriction.

In conclusion, the method for acquiring information according to the embodiment, by acquiring the associated information of the video element in the video, and by displaying the associated information acquired at the specified time, thus solves the problem of inefficient information acquisition, making it possible to display the associated information of the video element in the terminal device at the specified time, and improving the information acquisition efficiency.

The foregoing embodiments take an example in which the server generates in advance the associated information of at least one video element. And the server generating the associated information of a video element in real time according to an information acquisition request of the terminal device will be illustrated in the following embodiments.

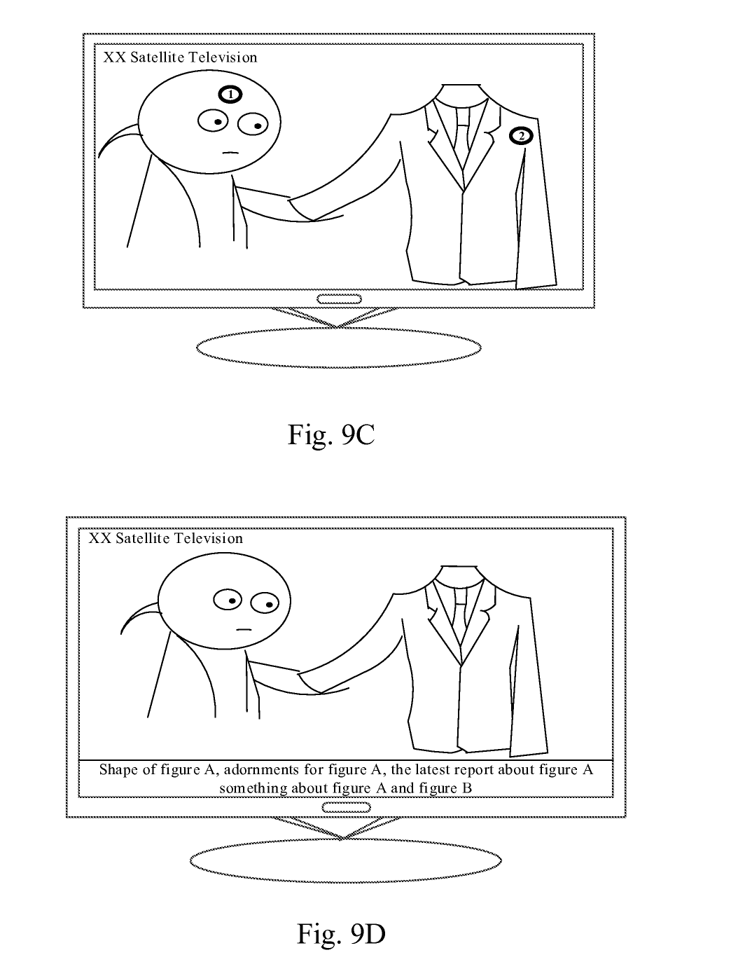

FIG. 8 is a flow chart showing a method for acquiring information according to an exemplary embodiment which is illustrated by applying the method to a terminal device 110 as shown in FIG. 1A or FIG. 1B and the terminal device 110 is able to, upon receiving an information acquisition instruction from a user, send an information acquisition request to the server, the server feeds back associated information generated to the terminal device, and the terminal device receives such associated information of a video element relating to a play position when the information acquisition instruction is received. The method for acquiring information may comprise following steps.

In Step 801, the terminal device receives the information acquisition instruction from the user.

In the process of playing a video by the terminal device, the user may send the information acquisition instruction to the terminal device by means of preset keys of the terminal device or preset keys of a remote control if they want to acquire the associated information of the video element at the current play position, correspondingly, the information acquisition instruction from the user is received by the terminal device. Herein, the user may send out the information acquisition instruction by pressing preset keys of the remote control, of course, the user may also send out the information acquisition instruction by simultaneously pressing two keys such as ‘0’ and ‘Enter’ keys, to which the embodiment makes no restriction.

In Step 802, the terminal device sends the information acquisition request to the server.

The terminal device sends the information acquisition request to the server once it receives the information acquisition instruction. Herein, the information acquisition request is configured to acquire the associated information of the video element relating to the play position.

In actual implementation, the step in which the terminal device sends the information acquisition request to the server may consist following steps.

Firstly, play information corresponding to a play position is acquired.

The terminal device may acquire the play information corresponding to the video play position when the information acquisition instruction is received. Herein, the play information comprises at least one of the following information: image frame data related to the play position, audio frame data related to the play position, and time frame corresponding to the play position of a timeline of the video. For example, the play information corresponding to the play position acquired by the terminal device is 15:14.

Secondly, the information acquisition request is sent to the server, the information acquisition request carrying a video identification of the video and the play information corresponding to the play position.

After acquiring the play information corresponding to the play position, the terminal device may send the server the information acquisition request carrying the video identification of the video and the play information corresponding to the play position. Herein, the video identification may be the name of the video or ID (identification) assigned by the server to the video, to which the embodiment makes no restriction.

In Step 803, the server receives the information acquisition request sent by the terminal device.

In Step 804, the server generates the associated information of at least one video element relating to the play position in the video, wherein each video element being an image element, a sound element or a clip in the video.

After receiving the information acquisition request, the server reads the video identification in the information acquisition request and the play information corresponding to the play position, thus generates the associated information of at least one video element relating to the play position corresponding to the play information in the video indicated in the video identification. Herein, the step in which the server generates the associated information of at least one video element relating to the play position in the video may comprise following steps.

The Step 804 includes two steps Step 804-1 and 804-2. In Step 804-1, at least one video element in the video is identified.

In actual implementation, the Step 804-1 may comprise the following substeps.

(1) After receiving the information acquisition request sent by the terminal device, the server acquires the play information corresponding to the play position carried in the information acquisition request, the play information comprising at least one of the following messages: image frame data relating to the play position, audio frame data relating to the play position, and time frame corresponding to play timeline of the play position; and

(2) According to the play information, the video elements corresponding to the play position in the video is acquired.

Herein, the information acquisition request is a request sent by the terminal device after receiving the information acquisition instruction from the user during a video, and the play position is a corresponding play position when the information acquisition instruction from the user is received by the terminal device during the video.

After acquiring the play information in the information acquisition request, the server may acquire, according to the play information, the video element corresponding to the play position in the video. In actual implementation, the step in which the server acquires the video element corresponding to the play position in the video comprises the following (a), (b) and (c) substeps.

(a) The video is decoded and at least one frame of video data is acquired.

The server decodes the video, and further acquires at least one frame of video data in the video. Herein, in the video, some play positions are configured with sound while other play positions are not configured with sound. The server may simultaneously decode and acquire image frame data and audio frame data at play positions configured with sound, and decode and acquire only image frame data at play positions not configured with sound.

(b) Concerning image frame data, image elements in the image frame data is identified by means of image recognition technology.

Concerning the image frame data acquired by decoding, the terminal device may identify the image elements in the image frame data by means of image recognition technology. In actual implementation, the server may match the image frame data acquired by decoding with images in an image database. If elements matching with images in the image database exist in the image frame data, the server takes the matched image elements as the image elements in the image frame data. Herein, the image database is a preset database comprising images including target objects such as figures, sceneries, articles for daily use, trappings, labels, trademarks, brands and keywords, to which the embodiment makes no restriction.

(c) Concerning audio frame data, sound elements in the audio frame data is identified by means of speech recognition technology.

Concerning the audio frame data, the terminal device may identify the sound elements in the audio frame data by means of speech recognition technology. In actual implementation, the server may match the audio frame data with a songbook, thus acquiring the sound elements in the audio frame data. Moreover, in order to more accurately identify a sound element, the server may combine an audio frame data with a preset length of audio frame data before the audio frame data, or with a preset length of audio frame data after the audio frame data, or with a preset length of audio frame data before the audio frame data and a preset length of audio frame data after the audio frame data, thus acquiring a multi-frame audio frame data and matching it with the songbook, to which the embodiment makes no restriction. Herein, the songbook includes a preset database comprising audio frequencies, to which the embodiment makes no restriction.

It should be explained that it is similar to the identification mode of a video element in Step 701 in the foregoing embodiments, with detailed technical details referred to in the foregoing embodiments, not to be repeated any more herein.

In Step 804-2, the associated information of each video element is acquired.

After acquiring at least one video element, the server may acquire the associated information of each video element. Herein, the mode in which the server acquires the associated information of the video element may comprise the two following possible implementations:

In a first possible implementation, the Step 804-2 may comprise the following substeps.

(1) Concerning each video element, at least one piece of information relating to the video element is acquired by means of information search technology.

Concerning each video element identified and acquired by the server, the server may acquire at least one piece of information relating to the video element by means of information search technology.

(2) At least one information is sorted according to a preset condition, and n associated information in the front of the sorting is acquired as the associated information of the video element, wherein n being a positive integer.

The server may sort at least one piece of information acquired according to the preset condition. Herein, the preset condition comprises: at least one of a correlation with the video element, a correlation with a user location, a correlation with a history usage record of the user, and a ranking of manufacturers or suppliers of video elements.

In a second possible implementation, the Step 804-2 may comprise the following substeps.

As the user may report the associated information for each video element, the server may receive the associated information reported by other terminal devices with respect to the video element. Herein, the other terminal devices are terminal devices used by other users, or, the other terminal devices are terminal devices used by manufacturers or suppliers of video elements. The associated information reported by the other terminal devices may be information sorted according to a certain sort order, to which the embodiment makes no restriction.

In Step 805, the server feeds back the associated information of the video element relating to the play position in the video to the terminal device.

After generating the associated information of the video element relating to the play position in the video, the server feeds back the associated information of the video element relating to the play position in the video to the terminal device.

In Step 806, the terminal device receives such associated information of the video element as relating to the play position fed back by the server.

In Step 807, the terminal device may display the associated information at a time after receiving the associated information of the video element relating to the play position.

In actual implementation, the user may want to acquire the associated information of the video element of the current play position when he/she sends out an information acquisition instruction. Therefore, the terminal device may immediately display the associated information relating to the play position once it is acquired.

In conclusion, the method for acquiring information according to the embodiment, by acquiring the associated information of the video element in the video, and by displaying the associated information acquired at the specified time, thus solves the problem of inefficient information acquisition, making it possible to display the associated information of the video element in the terminal device at the specified time, and improving the information acquisition efficiency.

In This embodiment, when the information acquisition instruction from the user is received, the information acquisition request carrying positional information corresponding to the video play position is generated, the information acquisition request is sent to the server, and further the associated information of the video element corresponding to the positional information is acquired from the server, thus ensuring the terminal device to display the associated information required by the user as long as he/she conducts an operation of an information acquisition instruction, thus improving the information acquisition efficiency and reducing user operation complexity.

It should be explained that in the foregoing embodiments, the mode of the terminal device in displaying associated information may comprise any one of the following modes.

Mode I:

The associated information is directly displayed by means of a predetermined mode if the terminal device is a playback device and a remote control corresponding to the playback device has no information display ability.

Herein, the predetermined mode comprises: at least one of a split screen mode, a list mode, a tagging mode, a scrolling mode, a screen popup mode and a window popup mode.

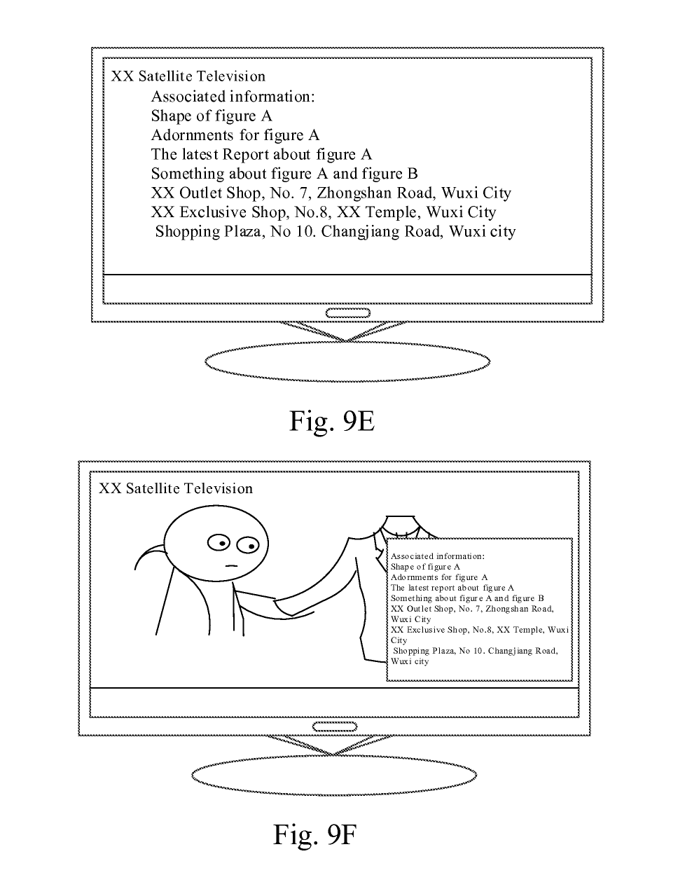

For example, please refer to FIG. 9A, an example is taken in which the terminal device is a television and a predetermined mode is the split screen mode, a scheduled position in a video is played by the television. For example, the television continues playing a video in a first display area 91 in a screen, and displays the associated information in a second display area 92.

Similarly, please refer to FIG. 9B, the television may also display the associated information by using the list mode. In this way, after the terminal device displays the associated information, a user may rapidly seek out information needed from the associated information displayed in the terminal device, thus improving the information acquisition efficiency and simplifying user operation.

Please refer to FIG. 9C, the television may also display the associated information by using the tagging mode. Herein, each tag is corresponding to the video element, the user may trigger a corresponding tag if they want to view the associated information of a certain video element, and further view the associated information corresponding to the tag. Herein, a terminal device interface may display a positioning cursor which is corresponding to a first tag by default, and the user may switch positions of the positioning cursor in tags by means of Page Up and Page Down keys of the remote control. When the positioning cursor is corresponding to a tag required for the user, he/she may trigger the corresponding tag by pressing Enter key of the remote control. In actual implementation, the terminal device may number tags before displaying tags. In this way, the user may select ‘1’ on the remote control and further trigger a first tag if he/she want to view the associated information corresponding to the first tag, to which the embodiment makes no restriction.

Please refer to FIG. 9D, the terminal device may also display the associated information by using the scrolling mode. In this way, the user may view corresponding associated information by viewing a scroll bar at the bottom of the screen while they are watching a video. It should be explained that FIG. 9D only takes an example in which the scroll bar is at the bottom of the screen. In actual implementation, the scroll bar may also be set at the left side, the right side or the top of the screen, to which the embodiment makes no restriction.

Please refer to FIG. 9E, the terminal device may also display the associated information by using the screen popup mode. In order to prevent the user from missing highlights of a video at the next moment, the terminal device may display the associated information in the screen popup mode. The terminal device may pause the video and continue playing the video when the user quits from display of the associated information, to which the embodiment makes no restriction.

Please refer to FIG. 9F, the terminal device may also display the associated information by using the window popup mode. In this way, the user may view corresponding associated information in a popup window displayed in the terminal device while they are watching a video.

Mode II:

If the terminal device is the playback device and the remote control corresponding to the playback device has information display ability, the associated information is directly displayed by means of a predetermined mode or the associated information is sent to the remote control configured to display the associated information by means of the predetermined mode.

When the terminal device is the playback device, and the remote control corresponding to the playback device is a device having information display ability, such as a mobile phone or a tablet computer and the like, the terminal device may directly display the associated information by means of the predetermined mode, or send the associated information to the remote control configured to display the associated information by means of the predetermined mode, to which the embodiment makes no restriction.

Mode III:

When the terminal device is a medium source device connected to the playback device and a remote control corresponding to the medium source device has no information display ability, the associated information is sent to the playback device which can display the associated information by means of a predetermined mode.

When the terminal device is the medium source device (such as “XX box”) connected to the playback device and the remote control corresponding to the medium source device has no information display ability, the terminal device may send the associated information to the playback device, and then the playback device may display the associated information by means of the predetermined mode.

Mode IV:

When the terminal device is the medium source device connected to the playback device and the remote control corresponding to the medium source device has information display ability, the associated information is sent to the playback device or the remote control configured to display the associated information by means of the predetermined mode.

Similarly, when the remote control corresponding to the medium source device has information display ability, the terminal device may send the associated information to the playback device or the remote control, and then the playback device or the remote control may display the associated information by means of the predetermined mode, to which the embodiment makes no restriction.

The embodiment only takes an example in which the associated information of at least one video element in the video is displayed at the same time. In actual implementation, if attribute information of the associated information includes a play position corresponding to the associated information, when the terminal device is playing the play position, the terminal device may display associated information corresponding to the play position, and further the terminal device may respectively display associated information at two or more play positions if there is associated information relating to two or more play positions, to which the embodiment makes no restriction.

It should also be explained that when the associated information is corresponding to two or more video elements, the terminal device may display their associated information in a menu mode, for example, the display schematic diagram of the terminal device is as shown in FIG. 9G when the terminal device displays in the split screen mode.

It shall be further explained that when the associated information of a displayed video element on the terminal device is triggered, the terminal device may also execute the following step of jumping to a play position corresponding to the video element in the video for playing; or jumping to information content corresponding to an information link comprised in the associated information for displaying.

After the terminal device displays the associated information, the user may trigger to display the associated information according to his/her needs. For example, when the associated information is displayed at end credits, the user may trigger the associated information if he/she wants to watch highlights (or wonderful clips) at a play position corresponding to the associated information once more. After being triggered, the associated information jumps to the play position corresponding to a video element in the video for playing. In this way, the user needs neither replay the video nor wait for the play position corresponding to the associated information to re-watch the corresponding highlights, thus gaining conveniences.

When the associated information comprises the information link, the user may trigger the associated information in order to view detailed information corresponding to the information link; after the associated information is triggered, the terminal device jumps to information content corresponding to the information link comprised in the associated information for displaying. In this way, the user may directly view the detailed information corresponding to the associated information in an information display interface after the terminal device is jumped, thus improving the information acquisition efficiency.

The step in which the terminal device jumps to the information content corresponding to the information link comprised in the associated information for displaying comprises the following substeps.

If the information link is an information introduction link, the terminal device jumps to information introduction corresponding to the information introduction link for displaying.

If the information link is a shopping information link, the terminal device jumps to shopping information corresponding to the shopping information link for displaying.

If the information link is a ticket information link, the terminal device jumps to ticket information corresponding to the ticket information link for displaying.

If the information link is a traffic information link, the terminal device jumps to traffic information corresponding to the traffic information link for displaying.

If the information link is a travel information link, the terminal device jumps to travel information corresponding to the travel information link for displaying.

If the information link is a figure social information link, the terminal device jumps to figure social information corresponding to the figure social information link for displaying, and if the information link is a comment information link, jumping to comment information corresponding to the comment information link for displaying.

For example, if the server determines associated information “the latest report of character A” of an image of “character A” as a link, when the user select the associated information displayed in the terminal device, the terminal device may jump to figure social information corresponding to the link for displaying; and if concerning an image of “a certain coat from XX brand”, information searched by the server also comprises a shopping link provided in an E-business network, when the user select the associated information, the terminal device may jump to shopping information corresponding to the shopping link for displaying.

The following is the embodiment of an apparatus in the present disclosure, which may be configured to execute the embodiment of the method in the present disclosure. Please refer to the embodiment of the method in the present disclosure with regard to undisclosed details about the embodiment of the device in the present disclosure.

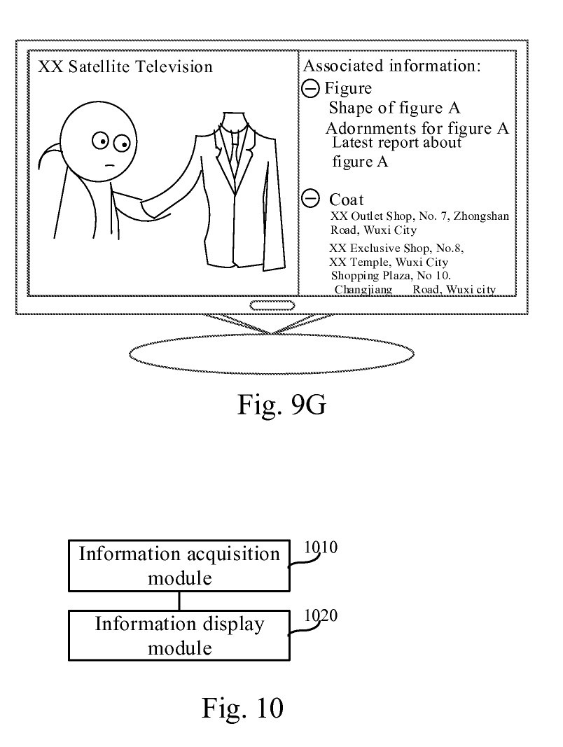

FIG. 10 is a block diagram of an apparatus for acquiring information according to an exemplary embodiment; the apparatus can be realized to become the terminal device shown in FIG. 1A or FIG. 1B in part or in whole by means of software or hardware or combination of both. The apparatus may comprise: an information acquisition module 1010 and an information display module 1020.

The information acquisition module 1010 is configured to acquire associated information of at least one video element in a video, wherein each video element is an image element, a sound element or a clip in the video; and the information display module 1020 is configured to display the associated information at a specified time.

In conclusion, the apparatus for acquiring information according to the embodiment, by acquiring the associated information of the video element in the video, and by displaying the associated information acquired at the specified time, thus solves the problem of inefficient information acquisition, making it possible to display the associated information of the video element in the terminal device at the specified time, and improving the information acquisition efficiency.

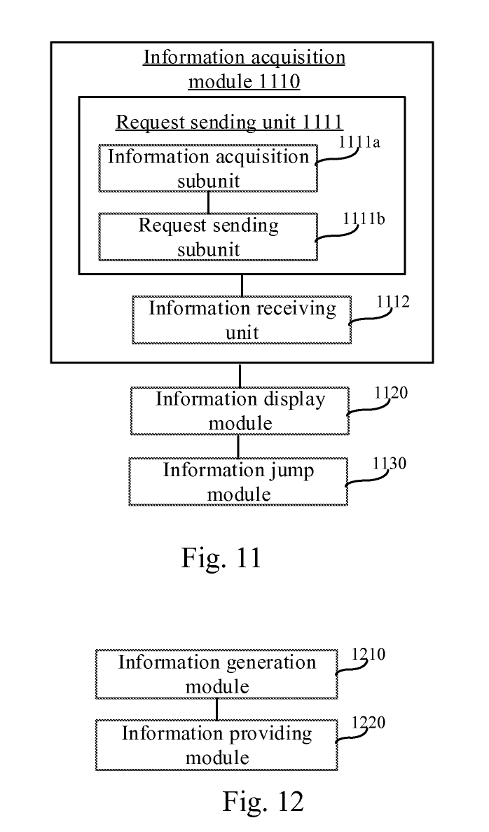

FIG. 11 is a block diagram of an apparatus for acquiring information according to an exemplary embodiment; the apparatus can be realized to become the terminal device shown in FIG. 1A or FIG. 1B in part or in whole by means of software or hardware or combination of both. The apparatus may comprise: an information acquisition module 1110 and an information display module 1120.

The information acquisition module 1110 is configured to acquire associated information of at least one video element in a video, wherein each video element is an image element, a sound element or a clip in the video.

The information display module 1120 is configured to display the associated information at a specified time.

In the first possible implementation according to the embodiment, the information acquisition module 1010 is configured to download the associated information of the at least one video element in the video from a server and to save the associated information at a scheduled time.

The scheduled time includes a period prior to playing the video, a period during the video or an idle moment.

In the second possible implementation according to the embodiment, the specified time includes a time when end credits of the video begin, a time when a pause signal during the video is received or a time when a scheduled position of the video is played.

In the third possible implementation according to the embodiment, the information acquisition module 1110 is configured to search, from associated information of at least one video element in a video downloaded in advance, for associated information of a video element relating to the play position if an information acquisition instruction from a user is received when playing a certain play position in the video.

In the fourth possible implementation according to the embodiment, the information acquisition module 1110 comprises: a request sending unit 1111, configured to send an information acquisition request to the server if the information acquisition instruction from the user is received, when playing a certain play position in a video, the information acquisition request being configured to acquire the associated information of the video element relating to the play position; and an information receiving unit 1112, configured to receive the associated information of the video element which is relative to the play position fed back by the server.

In the fifth possible implementation according to the embodiment, the request sending unit 1111 comprises: an information acquisition subunit 1111a, configured to acquire a play information corresponding to a play position, wherein the play information comprising at least one of image frame data relating to the play position, audio frame data relating to the play position, and time frame corresponding to play timeline of the play position; and a request sending subunit 1111b, configured to send the information acquisition request to the server, and the information acquisition request carrying a video identification of a video and the play information corresponding to the play position.

In the sixth possible implementation according to the embodiment, the specified time includes: a time after acquiring the associated information of the video element relating to the play position.

In the seventh possible implementation according to the embodiment, the information display module 1120 is configured to: if the terminal device is a playback device and a remote control corresponding to the playback device has no information display ability, display the associated information directly by means of a predetermined mode; if the terminal device is the playback device and the remote control corresponding to the playback device has information display ability, display the associated information directly by means of the predetermined mode or send the associated information to the remote control configured to display the associated information by means of a predetermined mode.

When the terminal device is a medium source device connected to the playback device and a remote control corresponding to the medium source device has no information display ability, the associated information is sent to the playback device configured to display the associated information by means of the predetermined mode.

When the terminal device is the medium source device connected to the playback device and the remote control corresponding to the medium source device has information display ability, the associated information is sent to the playback device or the remote control configured to display the associated information by means of the predetermined mode.

Herein, the predetermined mode comprises: at least one of a split screen mode, a list mode, a tagging mode, a scrolling mode, a screen popup mode and a window popup mode.

In the eighth possible implementation according to the embodiment, the device also comprises: an information jump module 1130, configured to, when the associated information of the displayed video element is triggered, jump to a play position corresponding to a video element in a video for playing or jump to information content corresponding to an information link comprised in the associated information for displaying.

In conclusion, the apparatus for acquiring information according to the embodiment, by generating the associated information of the at least one video element and providing the terminal device with the associated information of the at least one video element so as to display the associated information at the specified time after the associated information is acquired by the terminal device, thus solves the problem of inefficient information acquisition, making it possible to display the associated information of the video element by the terminal device at the specified time, and improving the information acquisition efficiency.

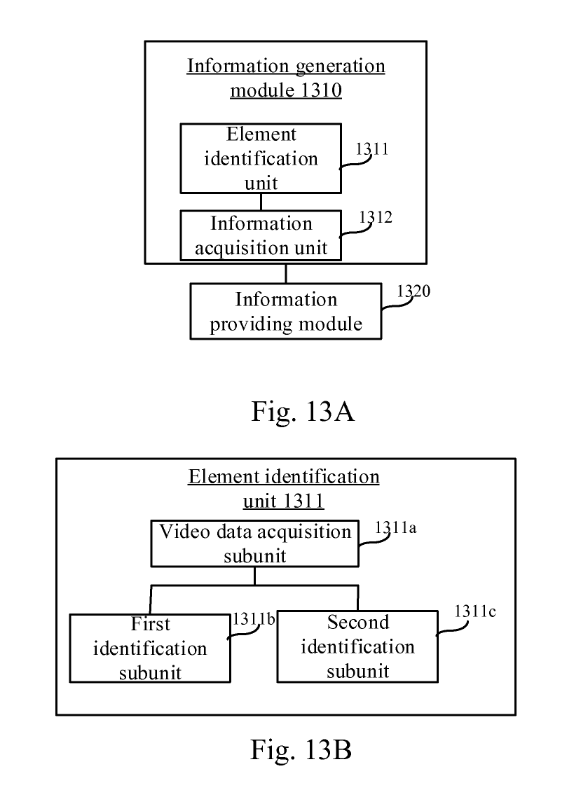

FIG. 12 is a block diagram of an apparatus for acquiring information according to an exemplary embodiment; the apparatus can be realized to become the server shown in FIG. 1A or FIG. 1B in part or in whole by means of software or hardware or combination of both. The information acquisition device may comprise: an information generation module 1210 and an information providing module 1220.

The information generation module 1210 is configured to generate associated information of at least one video element in a video, wherein each video element is an image element, a sound element or a clip in the video.

The information providing module 1220 is configured to provide a terminal device with the associated information of the at least one video element in the video, the terminal device being configured to display the associated information at a specified time. In conclusion, the apparatus for acquiring information according to the embodiment, by generating the associated information of the at least one video element and providing the terminal device with the associated information of the at least one video element so as to display the associated information at the specified time after the associated information is acquired by the terminal device, thus solves the problem of inefficient information acquisition, making it possible to display the associated information of the video element by the terminal device at the specified time, and improving the information acquisition efficiency.

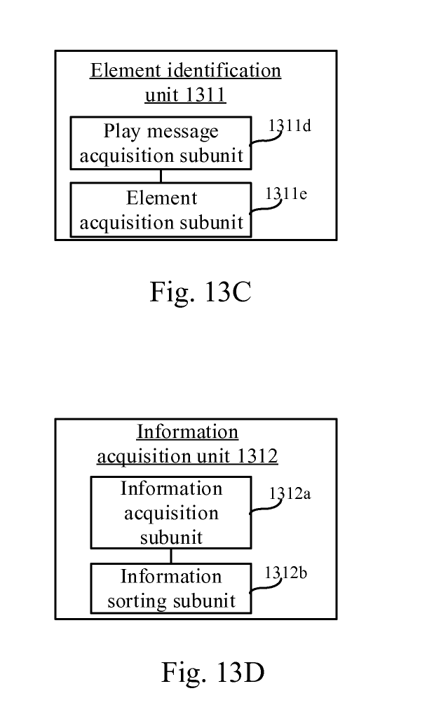

FIG. 13 is a block diagram of an apparatus for acquiring information according to an exemplary embodiment; the apparatus can be realized to become the server shown in FIG. 1A or FIG. 1B in part or in whole by means of software or hardware or combination of both. The information acquisition device may comprise: an information generation module 1310 and an information providing module 1320.

The information generation module 1310 is configured to generate associated information of at least one video element in a video, wherein each video element is an image element, a sound element or a clip in the video.

The information providing module 1320 is configured to provide a terminal device with the associated information of the at least one video element in the video, the terminal device being configured to display the associated information at a specified time.

In the first possible implementation according to the embodiment, the information providing module 1320 is configured to provide the terminal device with downloads to the associated information of the at least one video element in the video at a scheduled time.

The scheduled time includes periods prior to playing the video by the terminal device, during the video, or an idle moment of the terminal device.

In the second possible implementation according to the embodiment, the information providing module 1320 is configured to, after receiving an information acquisition request sent by the terminal device, feed back associated information of a video element relating to a play position in a video to the terminal device; wherein, the information acquisition request is a request sent by the terminal device after receiving an information acquisition instruction from a user during a video, and the play position is a corresponding play position when the information acquisition instruction from the user is received by the terminal device during the video.

In the third possible implementation according to the embodiment, the information generation module 1310 comprises: an element identification unit 1311, configured to identify at least one video element in the video; and an information acquisition unit 1312, configured to acquire associated information of each video element.

Referring to FIG. 13B, in the fourth possible implementation according to the embodiment, the element identification unit 1311 comprises: a video data acquisition subunit 1311a, configured to decode the video and acquire at least one frame of video data comprising image frame data or both image frame data and audio frame data; a first identification subunit 1311b, configured to, concerning image frame data, identify image elements in the image frame data by means of image recognition technology; and a second identification subunit 1311c, configured to, concerning audio frame data, identify sound elements in the audio frame data by means of speech recognition technology.

Referring to FIG. 13C, in the fifth possible implementation according to the embodiment, the element identification unit 1311 comprises: a play information acquisition subunit 1311e, configured to, after receiving an information acquisition request sent by the terminal device, acquire a play information corresponding to a play position carried in the information acquisition request; and an element acquisition subunit 1311f, configured to, according to the play information, acquire a video element corresponding to a play position in a video, the play information comprising at least one of image frame data relating to the play position, audio frame data relating to the play position, and time frame corresponding to the play position in a timeline of the video.

Herein, the information acquisition request is a request sent by the terminal device after receiving the information acquisition instruction from the user when playing the video. While the play position is a corresponding play position, when the information acquisition instruction from the user is received by the terminal device during the video.

In the sixth possible implementation according to the embodiment, the element identification unit 1311 is configured to receive at least one video element reported by other terminal devices to the video, and the video element is one labeled by users of the other terminal devices.

Referring to FIG. 13D, in the seventh possible implementation according to the embodiment, the information acquisition unit 1312 comprises: an information acquisition subunit 1312a, configured to, concerning each video element, acquire at least one piece of information of the video element by means of information search technology; and an information sorting subunit 1312b, configured to sort at least one piece of information according to a preset condition, and to acquire n associated information in the front of the sorting as the associated information of the video element, wherein n being a positive integer.

The preset condition comprises: at least one of a correlation with a video element, a correlation with a user location, a correlation with a history usage record of the user, and a ranking of manufacturers or suppliers of video elements.

In the eighth possible implementation according to the embodiment, the information acquisition unit 1312 is configured to receive associated information reported by the other terminal devices to the video element, and the other terminal devices are terminal devices used by other users, or, the other terminal devices are terminal devices used by the manufacturers or suppliers of the video element.

In conclusion, the apparatus for acquiring information according to the embodiment, by generating the associated information of the at least one video element and providing the terminal device with the associated information of the at least one video element so as to display the associated information at the specified time after the associated information is acquired by the terminal device, thus solves the problem of inefficient information acquisition, making it possible to display the associated information of the video element by the terminal device at the specified time, and improving the information acquisition efficiency.

With regard to the apparatus in the above embodiment, detailed description of specific modes for conducting operation of modules has been made in the embodiment related to the method, no detailed illustration will be made herein.

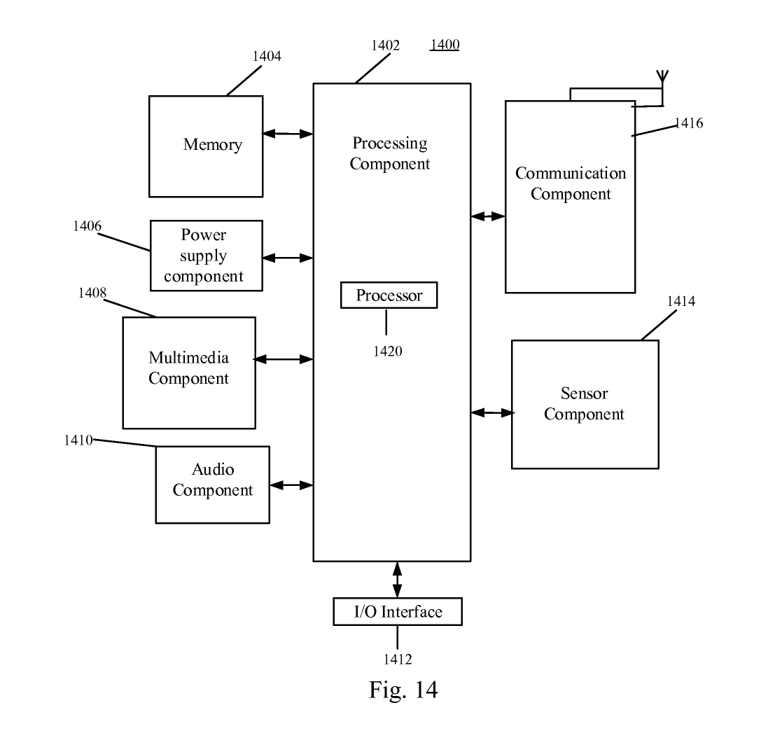

FIG. 14 is a block diagram of a device 1400 for acquiring information according to an exemplary embodiment. For example, the device 1400 may be a mobile telephone, a computer, a digital broadcasting terminal, a message transceiver device, a games console, a tablet device, a medical device, a fitness facility, a PDA (personal digital assistant) and the like.

Referring to FIG. 14, the device 1400 may include one or a plurality of components as below: a processor component 1402, a memory 1404, a power supply component 1406, a multimedia component 1408, an audio component 1410, an input/output (I/O) interface 1412, a sensor component 1414 and a communication component 1416.

The processor component 1402 usually controls the overall operation of the device 1400, for example, display, telephone call, data communication, and operation associated with camera operation and record operation. The processor component 1402 may include one or a plurality of processors 1420 for executing instructions so as to complete steps of above method in part or in whole. In addition, the processor component 1402 may include one or a plurality of modules for the convenience of interaction between the processor component 1402 and other components. For example, the processor component 1402 may include a multimedia module for the convenience of interaction between the multimedia component 1408 and the processor component 1402.

The memory 1404 is configured to store data of different types so as to support the operation of the device 1400. Examples of the data include any application program or approach directive for operation of the device 1400, including contact data, phonebook data, message, picture and video, etc. The memory 1404 may be realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 1406 provides power for components of the device 1400. The power supply component 1406 may include a power management system, one or a plurality of power supplies, and other components associated with generation, management and power distribution of the device 1400.

The multimedia component 1408 includes a screen between the device 1400 and a user and for providing an output interface. In some embodiments, the screen may include an LCD (Liquid Crystal Display) and a touch panel (TP). If the screen includes a touch panel, the screen may be realized as a touch screen for receiving input signal from users. The touch panel includes one or a plurality of touch sensors for sensing gestures on the touch panel, for example, touching and sliding, etc. The touch sensor not only can sensor trip boundary of touching or sliding, but also can detect the duration and pressure related to the touching or sliding operation. In some embodiments, the multimedia component 1408 includes a front-facing camera and/or a rear-facing camera. When the device 1400 is under an operation mode, for example, capture mode or video mode, the front-facing camera and/or the rear-facing camera may receive external multimedia data. Each front-facing camera and rear-facing camera may be a fixed optical lens system or have focal length and optical zoom capacity.

The audio component 1410 is configured to output and/or input audio signal. For example, the audio component 1410 includes a microphone (MIC); when the device 1400 is under an operation mode such as call mode, record mode and speech recognition mode, the microphone is configured to receive external audio signal. The audio signal received may be further stored in the memory 1404 or sent out by the communication component 1416. In some embodiments, the audio component 1410 also includes a loudspeaker for outputting audio signal.

The I/O interface 1412 provides interface for the processor component 1402 and peripheral interface modules, the peripheral interface modules may be a keyboard, a click wheel and buttons, etc. These buttons may include but not limited to: home button, volume button, start button and locking button.

The sensor component 1414 includes one or a plurality of sensors for providing the device 1400 with state evaluation from all aspects. For example, the sensor component 1414 may detect the on/off state of the device 1400, relative positioning of components, for example, the components are the displayer and keypads of the device 1400; the sensor component 1414 also may detect the position change of the device 1400 or a component thereof, the presence or absence of users' touch on the device 1400, the direction or acceleration/deceleration of the device 1400, and temperature variation of the device 1400. The sensor component 1414 may also include a proximity detector, which is configured to detect the presence of nearby objects in case of no physical touch. The sensor component 1414 may also include an optical sensor, for example, CMOS or CCD image sensor for imaging. In some embodiments, the sensor component 1414 may also include an acceleration sensor, a gyro sensor, a magnetic sensor, a pressure sensor, or a temperature sensor.

The communication component 1416 is configured to facilitate wired communication or wireless communication between the device 1400 and other equipment. The device 1400 is available for access to wireless network based on communication standards, for example, WiFi, 2G or 3G, or combination thereof. In an exemplary embodiment, the communication component 1416 receives by means of a broadcast channel the broadcast signal or broadcast-related information from external broadcast management systems. In an exemplary embodiment, the communication component 1416 also includes a near field communication (NFC) module for promoting short-range communication. For example, the NFC module may be realized on the basis of Radio Frequency Identification (RFID) Technology, Infrared Data Association (IrDA) Technology, Ultra-wide Bandwidth (UWB) Technology, Bluetooth (BT) Technology and other technologies.

In exemplary embodiments, the device 1400 may be realized by one or a plurality of application specific integrated circuits (ASIC), digital signal processors (DSP), digital signal processing equipment (DSPD), programmable logic devices (PLD), field programmable gate arrays (FPGA), controllers, microcontrollers, microprocessors or other electronic components, configured to execute the above methods.

In exemplary embodiments, a non-transitory computer-readable storage medium including instructions is also provided, for example, a memory 1404 including instructions, above instructions may be executed by the processors 1420 of the device 1400 so as to achieve the above methods. For example, the non-transitory computer-readable storage medium may be ROM, random access memory (RAM), CD-ROM, magnetic tape, floppy disk and optical data storage device, etc.

A non-transitory computer-readable storage medium may, when instructions in the storage medium are executed by the processor of the device 1400, cause the device 1400 to execute the foregoing methods of acquiring associated information of at least one video element in a video, wherein each video element being an image element, a sound element or a clip in the video, and displaying the associated information at a specified time.

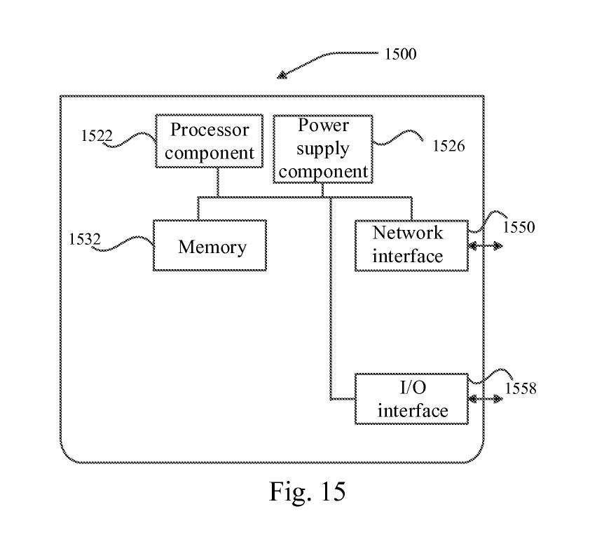

FIG. 15 is a block diagram of a device 1500 for acquiring information according to an exemplary embodiment. For example, the device 1500 may be implemented as a server. Referring to FIG. 15, the device 1500 includes a processor component 1522, and further includes one or a plurality of processors, and memory resource represented by the memory 1532 and configured to store instructions that can be executed by the processor component 1522, for example, application program. The application program stored in the memory 1532 may include one or a plurality of modules each of which is corresponding to a set of instructions. In addition, the processor component 1522 is configured to execute instructions so as to execute the foregoing method for acquiring information.

The device 1500 may also include a power supply module 1526 configured to execute the power management of the device 1500, a wired or wireless network interface 1550 configured to connect the device 1500 to the network, and an input/output (I/O) interface 1558. The device 1500 can operate an operating system based on and stored in the memory 1532, for example, Windows Server™, Mac OS X™, Unix™, Linux™, FreeBSD™ or other similar operating systems.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for acquiring information in a terminal device, comprising:
acquiring associated information of at least one video element in a video, wherein each video element being an image element, a sound element or a clip in the video; and
displaying the associated information at a specified time.

2. The method according to claim 1, wherein acquiring the associated information of the at least one video element in the video comprises:
downloading associated information of the at least one video element in the video from a server; and
saving the associated information at a scheduled time, which includes a period prior to playing the video, a period during the video or an idle moment.

3. The method according to claim 2, wherein the specified time comprises a time when end credits of the video begin and/or a time when a pause signal is received when playing the video.

4. The method according to claim 1, wherein acquiring the associated information of the at least one video element in the video comprises:
searching for associated information of a video element relating to a play position in the video from the associated information of at least one video element in the video downloaded in advance, if an information acquisition instruction is received from a user when playing the certain position in the video.

5. The method according to claim 1, wherein acquiring the associated information of the at least one video element in the video comprises:
sending an information acquisition request to the server if the information acquisition instruction is received from the user when playing the certain play position in the video, the information acquisition request being configured to acquire the associated information of the video element relating to the play position; and
receiving the associated information of the video element related to the play position of the video fed back by the server.

6. The method according to claim 5, wherein sending the information acquisition request to the server comprises:
acquiring play information corresponding to the play position, wherein the play information comprises at least one of image frame data related to the play position, audio frame data related to the play position, and a time frame corresponding to the play position in a timeline of the video; and
sending the information acquisition request, which carries a video identification of the video and the play information corresponding to the play position, to the server.

7. The method according to claim 4, wherein the specified time comprises a time when the associated information of the video element relating to the play position is acquired.

8. The method according to claim 1, wherein displaying the associated information at the specified time comprises:
if the terminal device is a broadcasting equipment and a remote control corresponding to the playback device has no information display ability, displaying the associated information directly in a predetermined mode;
if the terminal device is the playback device and the remote control corresponding to the playback device has information display ability, displaying the associated information directly in the predetermined mode, or sending the associated information to the remote control, which is configured to display the associated information in the predetermined mode;
if the terminal device is a medium source device connectable to the playback device and a remote control corresponding to the medium source device has no information display ability, sending the associated information to the playback device, which is configured to display the associated information in the predetermined mode; and
if the terminal device is the medium source device connectable to the playback device and the remote control corresponding to the medium source device has information display ability, sending the associated information to the playback device or the remote control, both of which are configured to display the associated information in the predetermined mode;
wherein, the predetermined mode comprises at least one of a split screen mode, a list mode, a tagging mode, a scrolling mode, a screen popup mode and a window popup mode.

9. The method according to claim 1, wherein the method further comprises:
when associated information of a displayed video element is triggered, jumping to a play position corresponding to the video element in the video to play.

10. The method according to claim 1, wherein the method further comprises:
when the associated information of the displayed video element is triggered, jumping to information content corresponding to an information link comprised in the associated information for displaying.

11. A method for acquiring information in a server, comprising:
generating associated information of at least one video element in a video, wherein each video element being an image element, a sound element or a clip in the video; and
providing a terminal device with the associated information of the at least one video element in the video, wherein the terminal device is configured to display the associated information at a specified time.

12. The method according to claim 11, wherein providing the terminal device with the associated information of the at least one video element in the video comprises:
providing the terminal device with downloads of the associated information of the at least one video element in the video at a scheduled time, which includes a period prior to playing the video by the terminal device, a period during the video or an idle moment.

13. The method according to claim 11, wherein providing the terminal device with the associated information of the at least one video element in the video comprises:
after receiving an information acquisition request sent from the terminal device, feeding back associated information of a video element of a play position in the video to the terminal device;
wherein the information acquisition request is a request sent from the terminal device after receiving an information acquisition instruction from a user during the video, and the play position is a corresponding play position when the information acquisition instruction from the user is received by the terminal device during the video.

14. The method according to claim 11, wherein generating the associated information of the at least one video element in the video comprises:
identifying the at least one video element in the video; and
acquiring associated information of each video element.

15. The method according to claim 14, wherein identifying the at least one video element in the video comprises:
decoding the video;
acquiring at least one frame of video data comprising image frame data or both image frame data and audio frame data;
identifying image elements in the image frame data, concerning the image frame data, by means of image recognition technology; and
identifying sound elements in the audio frame data, concerning the audio frame data, by means of speech recognition technology.

16. The method according to claim 14, wherein identifying the at least one video element in the video comprises:
acquiring a play information corresponding to a play position carried in the information acquisition request after receiving the information acquisition request sent from the terminal device; wherein the play information comprising at least one of image frame data related to the play position, audio frame data related to the play position, and a time frame corresponding to the play position of a timeline of the video; and
acquiring video elements corresponding to the play position in the video according to the play information,
wherein, the information acquisition request is the request sent from the terminal device after receiving the information acquisition instruction from the user during the video, and the play position is the corresponding play position when the information acquisition instruction from the user is received by the terminal device during the video.

17. The method according to claim 14, wherein identifying the at least one video element in the video comprises:
receiving at least one video element reported by other terminal devices with respect to the video, wherein the video element is labeled by users of the other terminal devices.

18. The method according to claim 14, wherein acquiring the associated information of each video element comprises:
acquiring at least one piece of information relating to each video element by means of information search technology;
sorting the at least one piece of information according to a preset condition; and
acquiring n associated information in the front of the sorting as the associated information of the video element, wherein n being a positive integer,
wherein the preset condition comprises at least one of a correlation with the video element, a correlation with a user location, a correlation with a history usage record of the user, and a ranking of manufacturers or suppliers of the video elements.

19. The method according to claim 14, wherein acquiring the associated information of each video element comprises:
receiving the associated information reported by the other terminal devices with respect to the video element, wherein the other terminal devices being terminal devices used by other users or manufacturers or suppliers of the video element.

20. A terminal device for acquiring information, comprising:
a processor; and
a memory configured to store executable instructions from the processor,
wherein, the processor is configured to perform:
acquiring associated information of at least one video element in a video, wherein each video element being an image element, an sound element or an element of a clip in the video; and
displaying the associated information at a specified time.

21. The terminal device according to claim 20, wherein acquiring the associated information of the at least one video element in the video comprises:
downloading associated information of the at least one video element in the video from a server; and
saving the associated information at a scheduled time, which includes a period prior to playing the video, a period during the video or an idle moment.

22. A server for acquiring information, comprising:
a processor; and
a memory configured to store executable instructions from the processor,
wherein, the processor is configured to perform:
generating associated information of at least one video element in a video, wherein each video element being an image element, an sound element or a clip in the video; and
providing a terminal device with the associated information of the at least one video element in the video, wherein the terminal device is configured to display the associated information at a specified time.

23. The server according to claim 22, wherein providing the terminal device with the associated information of the at least one video element in the video comprises:
providing the terminal device with downloads of the associated information of the at least one video element in the video at a scheduled time, which includes a period prior to playing the video by the terminal device, a period during the video or an idle moment.
